(19) United States
(12) Patent Application Publication
(10) Pub. No.: US 2026/0148443 A1
(43) Pub. Date: May 28, 2026

(54) RECORDING MEDIUM, IMAGE PROCESSING APPARATUS, AND IMAGE PROCESSING METHOD

(71) Applicant: Live2D Inc., Tokyo (JP)

(72) Inventor: Keiichi SAWADA, Tokyo (JP)

(73) Assignee: Live2D Inc., Tokyo (JP)

(21) Appl. No.: 19/256,399

(22) Filed: Jul. 1, 2025

Related U.S. Application Data
(63) Continuation of application No. PCT/JP2024/042206, filed on Nov. 28, 2024.

(51) Int. Cl. G06T 11/20; G06T 7/11; G06T 11/60

(52) U.S. Cl. CPC G06T 11/23; G06T 7/11; G06T 11/60

(57) ABSTRACT

A method edits illustration data having a layer structure in which image elements for forming an image of an illustration are separated into a plurality of layers. The method obtains the illustration data, sets a target region inside the illustration data, selects two or more target layers from among the plurality of layers, and for the target layers, generates image elements in the target region based on image elements outside the target region. The generation includes generating the image elements in the target region as a reference image based on an integrated image integrating image elements in the target layers, and for each of the target layers, generating the image element in the target region corresponding to the target layer based on the reference image and the image element outside the target region in the target layer.

### CROSS-REFERENCE TO RELATED APPLICATION(S)

This application is a continuation of International Patent Application No. PCT/JP2024/042206 filed on Nov. 28, 2024, the entire disclosures of which is incorporated herein by reference.

### BACKGROUND OF THE INVENTION

### Field of the Invention

The present invention relates to a recording medium, an image processing apparatus, and an image processing method, and particularly to a technique to generate an image of a predetermined region on the basis of a surrounding image.

### Description of the Related Art

There is technique to generate a model that enables a three-dimensional animation representation (hereinafter referred to as a three-dimensional representation) of a character corresponding to various viewing directions by preparing a two-dimensional image (illustration) of the character separated into image elements of respective parts, such as hair, eyebrows, eyes, and an outline (face), and by defining geometric transformation of curved surfaces corresponding to viewing directions different from the illustration with application of curved surfaces suitable for the parts (Japanese Patent Laid-Open No. 2009-104570).

Incidentally, according to the technique described in Japanese Patent Laid-Open No. 2009-104570, in order to realize, for example, a change in a viewing direction or a representation of shaking of parts and the like, it is necessary to prepare image elements also with respect to portions that are not shown in the two-dimensional illustration (that is occluded in the illustration) (hereinafter referred to as occluded portions). That is to say, a designer needs to additionally render information of the occluded portions as necessary while preparing image elements of parts in a state where information of occluded portions is included in advance in expectation of a three-dimensional representation that can be handled by a model, or while performing a task to separate the illustration into parts.

The latter method is advantageous in terms of its capability to generate a model that enables even a person with little knowledge about a three-dimensional representation to realize a favorable three-dimensional representation. However, for example, it is troublesome to additionally render information of occluded portions each time while defining geometric transformation of curved surfaces. Especially, in a case where illustration data is structured to include a plurality of layers corresponding to various representations of effects, this trouble increases in proportion to the number of layers with which parts are involved.

### SUMMARY OF THE INVENTION

The present invention has been made in view of the aforementioned problem, and provides a recording medium, an image processing apparatus, and an image processing method that efficiently generate image elements in a desired region in conformity with a layer structure of illustration data.

The present invention in its first aspect provides a computer-readable recording medium including a program recorded therein, the program editing illustration data having a layer structure in which image elements for forming a display image of an illustration are separated into a plurality of layers, the program causing a computer to execute: obtainment processing for obtaining the illustration data to be edited; setting processing for setting a target region inside a display image related to the illustration data obtained in the obtainment processing; selection processing for selecting two or more layers as target layers from among the plurality of layers; and generation processing for, with respect to the target layers selected in the selection processing, generating image elements in the target region on a basis of image elements outside the target region, the generation processing including first generation processing for generating the image elements in the target region as a reference image on a basis of an integrated image generated by integrating image elements in the target layers, and second generation processing for, with respect to each of the target layers, generating the image element in the target region corresponding to the target layer on a basis of the reference image and the image element outside the target region in the target layer.

The present invention in its second aspect provides an image processing apparatus that edits illustration data having a layer structure in which image elements for forming a display image of an illustration are separated into a plurality of layers, the image processing apparatus comprising: at least one processor; and at least one memory storing a computer program, which causes the at least one processor to function as following units: obtaining means for obtaining the illustration data to be edited; setting means for setting a target region inside a display image related to the illustration data obtained by the obtaining means; selecting means for selecting two or more layers as target layers from among the plurality of layers; and generating means for, with respect to the target layers selected by the selecting means, generating image elements in the target region on a basis of image elements outside the target region, wherein the generating means includes first generating means for generating the image elements in the target region as a reference image on a basis of an integrated image generated by integrating image elements in the target layers, and second generating means for, with respect to each of the target layers, generating the image element in the target region corresponding to the target layer on a basis of the reference image and the image element outside the target region in the target layer.

The present invention in its third aspect provides an image processing method that edits illustration data having a layer structure in which image elements for forming a display image of an illustration are separated into a plurality of layers, the image processing method comprising: obtaining the illustration data to be edited; setting a target region inside a display image related to the obtained illustration data; selecting two or more layers as target layers from among the plurality of layers; and with respect to the selected target layers, generating image elements in the target region on a basis of image elements outside the target region, wherein the generating includes generating the image elements in the target region as a reference image on a basis of an integrated image generated by integrating image elements in the target layers, and with respect to each of the target layers, generating the image element in the target region corresponding to the target layer on a basis of the reference image and the image element outside the target region in the target layer.

Further features of the present invention will become apparent from the following description of exemplary embodiments (with reference to the attached drawings).

### BRIEF DESCRIPTION OF THE DRAWINGS

FIG. 1 is a block diagram exemplarily showing a hardware configuration of a PC 100 according to embodiments and modification examples of the present invention;

FIG. 2A is a diagram for describing sorting of parts in an illustration;

FIG. 2B is another diagram for describing sorting of parts in an illustration;

FIG. 2C is still another diagram for describing sorting of parts in an illustration;

FIG. 3A is a diagram for describing a color spreading function according to embodiments and modification examples of the present invention;

FIG. 3B is another diagram for describing the color spreading function according to embodiments and modification examples of the present invention;

FIG. 3C is still another diagram for describing the color spreading function according to embodiments and modification examples of the present invention;

FIG. 3D is still another diagram for describing the color spreading function according to embodiments and modification examples of the present invention;

FIG. 3E is still another diagram for describing the color spreading function according to embodiments and modification examples of the present invention;

FIG. 3F is still another diagram for describing the color spreading function according to embodiments and modification examples of the present invention;

FIG. 3G is still another diagram for describing the color spreading function according to embodiments and modification examples of the present invention;

FIG. 4 is a flowchart exemplarily showing generation processing executed by the PC 100 according to a first embodiment of the present invention;

FIG. 5A is a diagram for describing setting of a target region according to a second embodiment of the present invention;

FIG. 5B is another diagram for describing setting of the target region according to the second embodiment of the present invention;

FIG. 5C is still another diagram for describing setting of the target region according to the second embodiment of the present invention;

FIG. 6A is a diagram for describing generation of a reference image according to the second embodiment of the present invention;

FIG. 6B is another diagram for describing generation of the reference image according to the second embodiment of the present invention;

FIG. 6C is still another diagram for describing generation of the reference image according to the second embodiment of the present invention; and

FIG. 6D is still another diagram for describing generation of the reference image according to the second embodiment of the present invention.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The following describes an embodiment using an example in which the present invention is applied to a PC which serves as an example of an image processing apparatus, and which can edit illustration data that has a layer structure. However, the present invention is applicable to any device that can edit illustration data that has a layer structure.

Also, in the present specification, a “representation model” will be described as data that is configured to be capable of realizing a three-dimensional representation of a two-dimensional image (illustration) in which an object, such as a character, has been rendered. The representation model is configured to include a curved surface to which a two-dimensional image of a part is applied as a texture for each part of the object, and deformations of each curved surface are defined in advance in relation to discrete states of the object. Due to this definition, in a case where, for example, information of an orientation has been provided, rendering is performed with each curved surface deformed in a state where it corresponds to this orientation, and accordingly, the representation model can form a two-dimensional image of the character showing an external view of this state. Therefore, by providing a state that continuously changes with respect to the representation model, a representation of animation in which the illustration of the object appears to be moving three-dimensionally can be provided.

### (Configuration of PC 100)

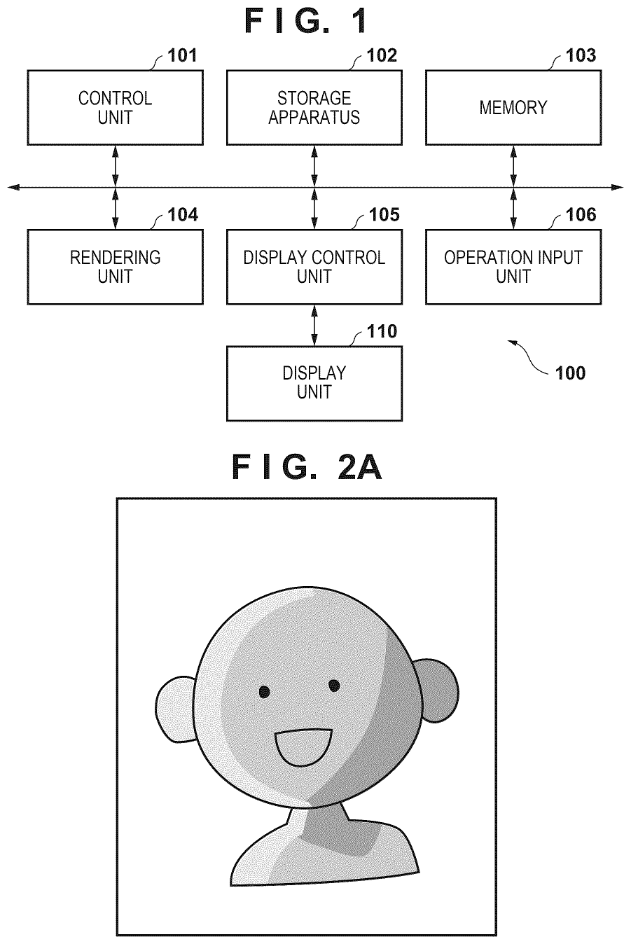

FIG. 1 is a block diagram showing a hardware configuration of a PC 100 according to an embodiment of the present invention.

A control unit 101 is, for example, a control apparatus, such as a CPU, and controls the operations of each block included in the PC 100. Specifically, the control unit 101 controls the operations of each block by reading out a program related to an operating system stored in a storage apparatus 102, a program related to an illustration editor application that edits illustration data for a representation model, and the like, deploying the programs to a memory 103, and executing the programs.

The storage apparatus 102 is, for example, an information storage apparatus, such as a rewritable nonvolatile memory like a ROM, and an HDD that is attachably/removably connected to the PC 100. Also, the storage apparatus 102 may include, for example, a recording medium like a disc that is accessible via a predetermined, readable and writable interface, such as an optical drive. The storage apparatus 102 stores not only the aforementioned programs, but also information necessary for the operations of each block, such as parameters, and illustration data, for example.

The memory 103 is, for example, a volatile memory like a RAM. The memory 103 is used not only as a deployment region to which programs and the like that have been read out from the storage apparatus 102 are deployed, but also as a storage region that stores, for example, intermediate data output in the operations of each block. Alternatively, the memory 103 is also used as a region that stores, for example, an intermediate computation result and a computation result during the execution of any processing.

A rendering unit 104 is, for example, a rendering apparatus like a GPU. The rendering unit 104 generates screens (images) to be displayed in a display region of a display unit 110. The screens generated by the rendering unit 104 are successively displayed on the display unit 110 as a result of a display control unit 105 executing display control processing.

The display unit 110 may be, for example, a display apparatus like an LCD. Although the present embodiment will be described assuming that the display unit 110 is a constituent element included in the PC 100, embodiments of the present invention are not limited to this. The display unit 110 need not be configured so as to have the same housing as the PC 100, and may be an external display apparatus that is attachably/removably connected to the PC 100.

An operation input unit 106 is, for example, a user interface included in the PC 100, such as a mouse, a keyboard, a pen tablet, a game controller, and the like. Upon detecting an operation input that has been performed with respect to various types of interfaces, the operation input unit 106 outputs a control signal corresponding to this operation input to the control unit 101. Alternatively, the operation input unit 106 notifies the control unit 101 of the occurrence of an event corresponding to this operation input.

### (Overview of Illustration Editor Application)

The following describes an overview of the illustration editor application that edits illustration data for a representation model in the PC 100 of the present embodiment. The illustration editor application reads in illustration data to be edited, and generates, from this illustration data, a texture group that is applied to curved surfaces corresponding to the respective parts of the representation model. That is to say, the illustration editor application executes processing for cutting the illustration data to be edited into images that are applied to the respective parts of the representation model as textures. Hereinafter, this processing provided by the illustration editor application will be simply referred to as sorting of parts.

(illustration Data to be Edited)

It is assumed that illustration data read by the illustration editor application of the present embodiment has a layer structure including a plurality of layers. In general, an illustration related to the illustration data is produced by using successive layers that are different from one another in a production process of the illustration. In one mode, different layers are added and used for respective working tasks of the production process, such as line art and coloring (coloring with a base color, coloring with a highlight color, and coloring with a shadow color), for example. That is to say, image information pieces of different representations of effects are stored in the respective layers, and image information pieces of a plurality of layers need to be composited together to form a display image of the illustration.

A hierarchical relationship is defined for the plurality of layers; in forming a display image, the composition is performed in a mode where image information of an upper-level layer located at the same position as image information of a lower-level layer is superimposed on the image information of the lower-level layer. Also, in which mode the image information pieces of the respective layers are to be composited together (e.g., multiplication, addition, and the like) in forming a display image is controlled based on information pieces that are defined for the respective layers. In the present embodiment, composition of image information pieces of a plurality of layers in a composition mode defined for the layers will be simply referred to as “integration” of the plurality of layers.

Hereinafter, image information included in one layer will be referred to as an “image element” as an element for forming a display image. On the other hand, image information pieces formed by integrating image elements of a plurality of layers will be referred to as an “image”. Although these terms are separately used to facilitate the understanding of the invention in the present embodiment, the image element and the image are both image information, and may be replaced with each other as appropriate to understand the invention. For example, in a mode where an image generated by integrating image elements of a plurality of layers is managed as one layer, this image can be the image elements (of this one layer). Also, in a mode of a layer group in which one layer includes a layer that is further therebelow, an image element of one layer (group) can be an image obtained by integrating image elements of the plurality of layers.

### (Sorting of Parts)

The illustration editor application provides a user mainly with various functions related to sorting of parts in an illustration.

Sorting of parts in an illustration related to illustration data is performed while the display unit 110 is displaying a display image of this illustration related to the illustration data, on the basis of an operation input that designates a region inside the illustration (display image). When the region inside the illustration has been designated, image information pieces dispersed inside this region can be separated and packaged as information for one part. As described above, as the illustration data has a layer structure including a plurality of layers, the image information pieces dispersed in the designated region can be composed of image elements of two or more layers. Therefore, packaging may be performed in a mode where, for example, the layer structure of the image elements inside the region is maintained, in accordance with a definition of a new layer group obtained by separating the image elements dispersed inside this region. That is to say, in a case where five types of layers 1 to 5 are provided with respect to illustration data and a designated region includes image elements of three types of layers 1, 2, and 4 among these, a new layer group generated by packaging is configured in such a manner that the hierarchical relationship among these three types of layers is maintained, and image information pieces included inside the region among the image elements of the layers 1, 2, and 4 are stored as image elements of the respective layers.

Note that as it is hard for the user to accurately input an operation input for designating a desired region, parts may be sorted using a layer mask so that the region can be flexibly adjusted thereafter. For example, in the aforementioned example, parts may be sorted as follows: with respect to a part to be separated, copies of the layers 1, 2, and 4 are made and added to a new layer group, and a layer mask that causes the designated region to be displayed and prevents the outside of this region from being displayed is applied with respect to each of these layers. At this time, with regard to a layer from which an image element is separated, the separation of the image element can be reflected by applying a layer mask that conversely prevents the designated region from being displayed and causes the outside of this region to be displayed.

Incidentally, a representation model is configured to show an external view similar to an illustration in a base state, and presents a three-dimensional representation by geometrically transforming curved surfaces to which textures for respective parts have been applied in accordance with a state (hereinafter simply referred to as deformation of parts). Therefore, in a case where parts are sorted by designating regions in an illustration, deformation of parts in an upper-level layer (group) (parts dispersed at the front (in the viewing direction) in the three-dimensional representation) can change an occluded state of parts in a lower-level layer (parts dispersed in the back in the three-dimensional representation).

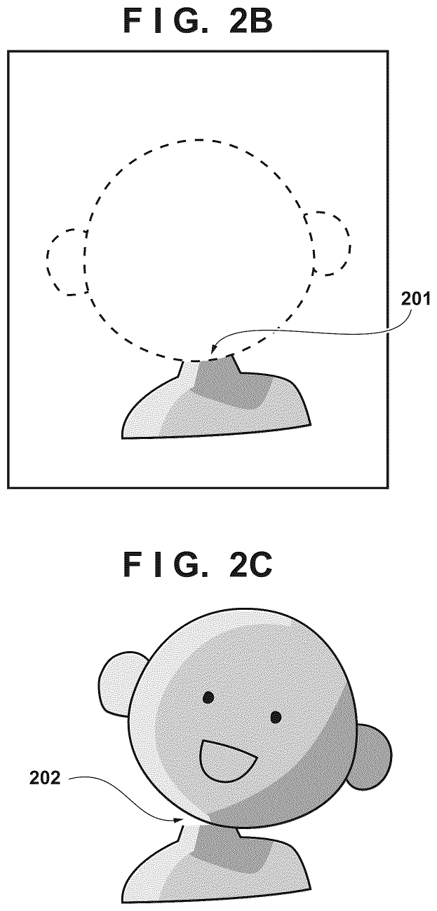

In a case where parts are sorted from an illustration, a part (hereinafter referred to as a back part) that is at least partially occluded by a part (hereinafter referred to as a front part) that is rendered at the front in this illustration does not include image information in a region in which this front part is rendered. For example, in an illustration in which a character is captured from the front as shown in FIG. 2A, a chin portion of a face can rendered in such a manner that it occludes a part of a neck. Therefore, in a case where these are sorted into parts, a part including the neck does not include image information of a neck root portion 201 as shown in FIG. 2B. Therefore, in a case where a front part (a face part) has been deformed, a region 202 that has not been rendered in the illustration can be displayed with regard to a back part (the part including the neck) as shown in FIG. 2C. That is to say, the region 202 can be displayed in a state where it is not occluded by the front part. As a result, an unnatural three-dimensional representation in a state where there is a disconnection between parts is displayed.

Therefore, in a case where parts are sorted while setting regions in an illustration, image information of a region in which the occlusion relationship can change due to deformation of a front part needs to be compensated with respect to a back part.

### (Color Spreading)

The illustration editor application of the present embodiment has a “color spreading” function as a function to compensate image information of a region that can be displayed due to a change in the occlusion relationship caused by deformation of another part.

By setting a target region inside a display image of a selected part, or inside a display image of an illustration (in which parts have not been defined yet), and using the color spreading function, the user can generate image information of this target region. More specifically, with regard to the target region, the color spreading function generates an image element of the target region so as to achieve a state where “coloring” dispersed around the target region is also reflected in the target region. That is to say, with the color spreading function, an image element of the target region is generated with reference to an image element outside the target region. As a result, coloring outside the target region and coloring in the target region become connected together, and the display image can be changed to a state where coloring outside the target region is substantially spread in the target region. Hereinafter, in order to facilitate the understanding of the invention, an image element outside the target region that is referred to in generating an image element in the target region may be referred to as a “source element”, and an image of the target region that is generated with reference to the source element may be referred to as a “complementary element”, to make a strict distinction therebetween.

The illustration editor application of the present embodiment generates a complementary element based on a source element with use of an inference made by a learned model. This learned model is, for example, an inference model constructed by machine learning in which, with respect to an image in which image information of a partial region is missing, an image without any missing image information is provided as supervisory data so as to infer the image information of this partial region. In other words, this learned model is constructed to receive, as inputs, a designated region and an image around the designated region, and infer an image of the designated region. Therefore, with the color spreading function, information of a source element and a target region is input to the learned model, and consequently, an image element obtained as an inference result is used as a complementary element.

For example, the learned model may be implemented in a program as one function of the illustration editor application, or may be implemented in an external apparatus configured to be capable of communicating with the PC 100, such as an external server. In the latter case, the illustration editor application may include a program that obtains information of a complementary element, which is an inference result, from the external apparatus by transmitting information of a source element and a target region with use of, for example, an API provided by the external apparatus for inference.

Incidentally, as illustration data can include layers corresponding to various representations of effects as stated earlier, coloring outside a target region to be connected with the target region can be formed by image elements in a plurality of layers. Image elements that are included in illustration data while being separated into a plurality of layers are designed with an intention to provide different effects, such as coloring with a base color, coloring of a shadow, and coloring of a highlight, for example. These image elements are important to create the atmosphere of an original illustration also in a three-dimensional representation of a representation model, and are preferably in a state where curved surfaces are assigned thereto individually, and definitions of geometric transformation can be made. That is to say, in a case where source elements are provided in a plurality of layers around a target region, it is necessary to generate an image element on a layer-by-layer basis while ensuring such a layer structure also with respect to the target region. That is to say, it is necessary to generate a corresponding complementary element with respect to each of the plurality of layers that store the source elements.

Therefore, the illustration editor application of the present embodiment causes the user to select, as a target layer, a layer that includes an image element corresponding to “coloring” to be compensated in a target region with use of the color spreading function. In other words, with the color spreading function, a layer that stores a source element to be referred to as coloring outside the target region is selected as a target layer, and is referred to when generating coloring of the target region. Therefore, the illustration editor application of the present embodiment is configured to be capable of selecting one or more layers as target layers in the color spreading function.

Here, when one layer colored with a single color is selected as a target layer, it is sufficient to generate an image element of this target layer by filling a target region with pixels of the same color, and thus color spreading desired by the user can easily be realized. On the other hand, when two or more layers are selected as target layers, if image elements of a target region are generated respectively based on colorings of the target layers, there is a possibility that the occlusion relationship between image elements in the layers is not ensured in the target region, and a display image related to the target region and a display image related to the outside of the target region are not favorably connected together. More specifically, each of the two or more target layers stores an image element intended to provide an individual effect representation; thus, even if the learned model makes an inference while using these as individual inputs, for example, an image element obtained by filling the entirety of the target region with an effect color related to each target layer is inferred as a complementary element corresponding to this target layer. Therefore, the complementary element in the upper-level layer occludes the complementary element in the lower-level layer, and the display image related to the target region does not show the tendency of coloring variations similar to those outside the target region, for example. In other words, as the atmosphere of an illustration related to illustration data is created by mutual interaction among image elements stored in a plurality of layers, even if an image element of the target region is inferred simply for each target layer without referring to image elements stored in other layers, creation of a similar atmosphere in the display image related to the target region is not ensured.

On the other hand, by generating in advance an integrated image in which image elements in target layers are integrated and causing the learned model to make an inference while using this integrated image as an input, an image of a target region can be generated in which the atmosphere similar to that of a display image related to the outside of the target region is created. That is to say, when representations of effects related to a plurality of target layers are integrated in an image input to the learned model, an image including these representations of effects can be obtained as an inference result with respect to a target region. On the other hand, as stated earlier, in order to create the atmosphere similar to that of an illustration related to illustration data in a three-dimensional representation of a representation model, it is preferable that image elements that indicate respective representations of effects while being separated into layers in the illustration data can be revised individually. However, in an image of a target region inferred based on an integrated image, as a plurality of representations of effects have been integrated, image elements indicating the respective representations of effects cannot be revised individually. In other words, as an image of a target region that has been inferred in relation to an integrated image does not have a layer structure (is not inferred while being separated into layers) like image elements that form a display image related to the outside of the target region, an image element indicating a specific effect representation cannot be revised independently of an image element indicating another effect representation. Therefore, in color spreading of the target region, it is necessary to generate corresponding complementary elements through separation into layers that respectively correspond to a plurality of layers that store source elements in illustration data.

For this reason, in a case where a plurality of layers are selected as target layers, the illustration editor application of the present embodiment first generates an integrated image in which image elements of these target layers are integrated, and uses an image that has been inferred by the learned model while using this integrated image as an input as a “reference image” for generating an image element of a target region. As the integrated image is an image that reflects mutual interaction among representations of effects of the respective image elements stored in the plurality of target layers as stated earlier, the reference image shows the atmosphere created by image elements in the target layer group outside the target region.

Therefore, by specifying, from the reference image generated in the foregoing manner, regions indicating representations of effects corresponding to source elements in the respective target layers, regions in which complementary elements corresponding to the source elements in the respective target layers are to be generated can be specified in color spreading related to the target region. That is to say, in a case where a complementary element corresponding to a target layer is simply inferred from a source element for each target layer, information input to the learned model is limited to a source element in one target layer, and thus image information related to this source element is dispersed in the entirety of the target region according to an obtained complementary element; however, by generating a complementary element only in a region corresponding to this source element in the reference image, complementary elements that have been separated for the respective representations of effects can be obtained with respect to the target region. In other words, by undergoing the generation of the integrated image and the generation of the reference image, complementary elements that are highly convenient (separated into layers) can be generated with respect to the target region compared to a case where a complementary element corresponding to a target layer is simply inferred from a source element for each target layer.

Here, the reference image can be divided into regions with use of any region dividing method. In one mode, it is possible to adopt a region growing method in which neighboring pixels having similar pixel values are included as a region. Also, which divided region inside the reference image corresponds to which target layer (or a source element therein) can be specified based on color information of pixels dispersed in divided regions, information of information of positions at which divided regions are dispersed in the reference image, and the like. In one mode, a divided region that neighbors (exhibits continuity with) a region in which a source element is dispersed in one target layer can be specified as being in correspondence with this target layer. Furthermore, in another mode, for example, a statistical amount of color information of pixels included in a divided region (e.g., an average value of pixel values) can be compared with statistical amounts of color information of pixels included in source elements in the respective target layers, and a target layer with the smallest difference can be specified as a target layer corresponding to the divided region. For example, the k-means method can be used in specification of a corresponding target layer based on statistical amounts. Alternatively, to which target layer a divided region corresponds may be specified using both of similarity based on color information and continuity between the divided region and a source element. However, it is to be easily understood that the foregoing methods are not the only methods to specify to which target layer a divided region corresponds, and other methods can be adopted.

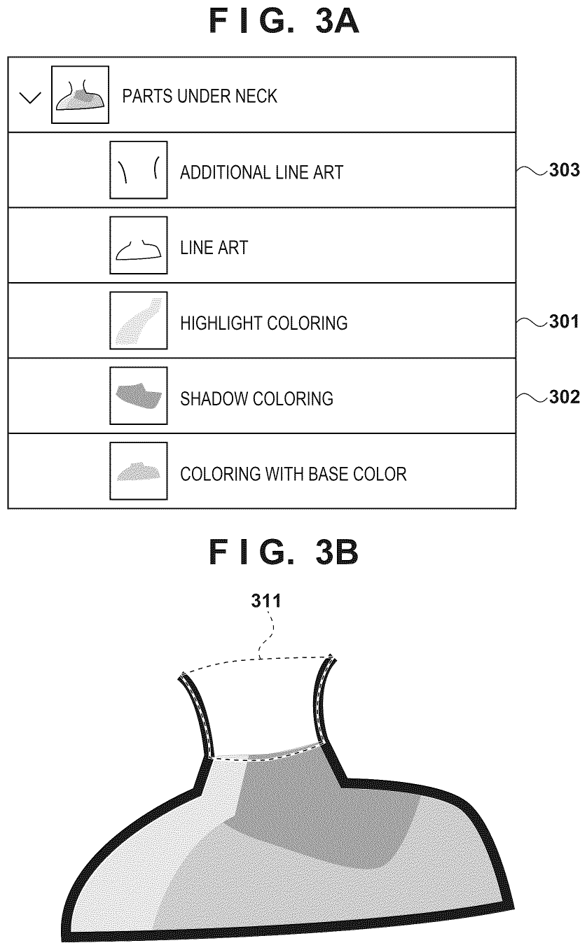

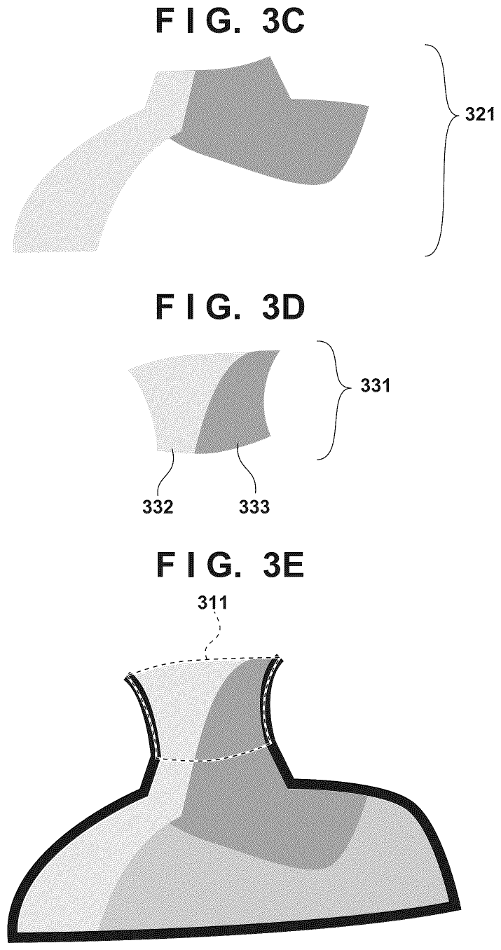

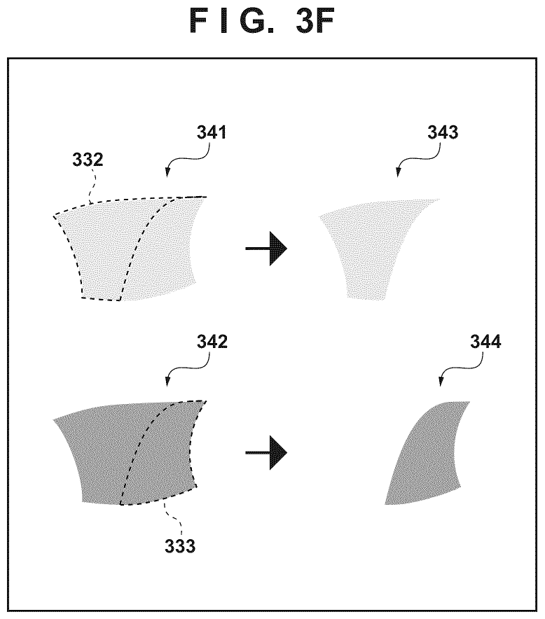

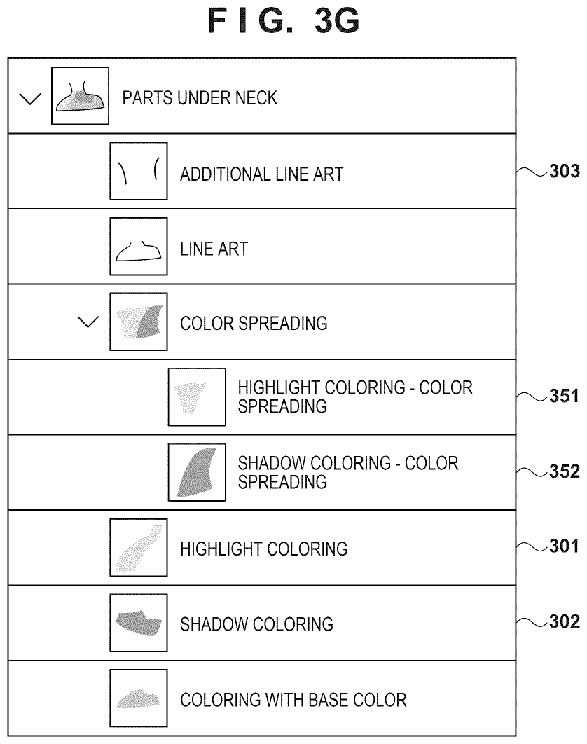

With use of drawings, the following describes an example in which a target region 311 is set with respect to a display image shown in FIG. 3B that is formed by image elements having a layer structure shown in FIG. 3A, and layers 301 and 302 are selected as target layers, as a mode of use of the color spreading function. The display image shown in FIG. 3B corresponds to an image obtained by adding line art that serves as outlines of a neck (an image element in a layer 303) to a display image of parts including a neck that has remained after separating an image of a face portion from the illustration of the character shown in FIG. 2A. Note that although the target region 311 is set in a mode where it includes parts of the image elements in the layers 301 and 302 along the line art indicating the outlines of the neck in the example of FIG. 3B, embodiments of the present invention are not limited to this. It is sufficient that the target region be set inside the display image related to illustration data, and it is not indispensable that the target region be set while overlapping an image element in any of the layers.

In this case, first, an integrated image 321 shown in FIG. 3C is generated by integrating image elements (source elements) in the layers 301 and 302 selected as the target layers. When information of this integrated image 321 and the target region 311 has been input to the learned model, a reference image 331 shown in FIG. 3D is output as an inference result. As shown, the content of the reference image 331 reflects the features of dispersion modes of the source elements in the layer 301 and the layer 302 in the integrated image 321, and this content exhibits continuity with the source elements in the layers 301 and 302 outside the target region when arranged in the target region as shown in FIG. 3E.

Here, by dividing the reference image 331 into regions, the reference image 331 can be divided into a divided region 332 corresponding to the layer 301 and a divided region 333 corresponding to the layer 302 as shown in FIG. 3D. Accordingly, with respect to the target region, it is sufficient to generate a complementary element indicating coloring that is restricted to the region of the divided region 332 for the source element in the layer 301, and a complementary element indicating coloring that is restricted to the region of the divided region 333 for the source element in the layer 302.

In one mode, as shown in FIG. 3F, each complementary element can be generated by extracting pixels corresponding to the divided region 332 from an image 341 of the size of the target region, which has been inferred by the learned model while using the source element in the layer 301 as an input, and by extracting pixels corresponding to the divided region 333 from an image 342 of the size of the target region, which has been inferred by the learned model while using the source element in the layer 302 as an input. Here, a display image similar to the reference image 331 shown in FIG. 3D can be formed by displaying the complementary element 343 generated by being extracted from the image 341 together with the complementary element 344 generated by being extracted from the image 342.

Also, in another mode, the image complementary element 343 and the complementary element 344 may be generated directly by setting each of the divided region 332 and the divided region 333 specified based on the reference image 331 as a region to be inferred by the learned model. That is to say, in this mode, while the target region 311 is set, information of a source element in a target layer and a divided region corresponding thereto (332 or 333) is input to the learned model when generating the complementary elements 343 and 344 on the basis of the reference image 331.

The complementary elements 343 and 344 generated in the foregoing manner are respectively stored in different new layers to be in a state where they can be revised individually, while distinguished from the image elements in the layer 301 and the layer 302 that were originally included in the illustration data. That is to say, as a result of the execution of color spreading with respect to the target region 311, the layer structure of the display image of parts including the neck is placed in a mode where the complementary element 343 is stored in a layer 351 different from the layer 301, and the complementary element 344 is stored in a layer 352 different from the layer 302, as shown in FIG. 3G. In this way, versatility that enables flexible measures can be realized also in a case where a mode intended by the user has not been achieved by the inference, or a case where the image elements to which color spreading has been applied are to be revised individually, for example.

### (Generation Processing)

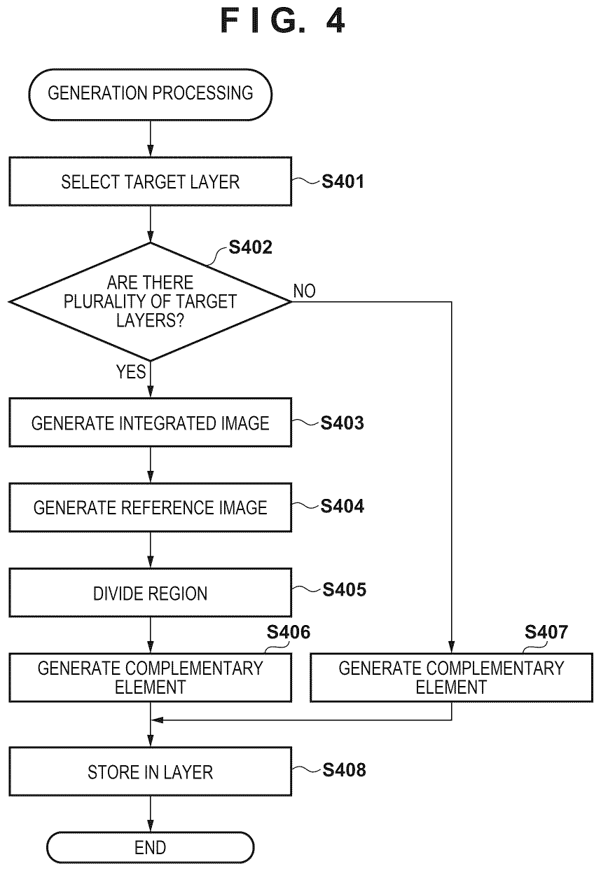

Using a flowchart of FIG. 4, the following describes specific processing in connection with generation processing that is executed in the PC 100 of the present embodiment in relation to generation of a complementary element for a target region. Processing corresponding to this flowchart can be realized by, for example, the control unit 101 reading out a corresponding processing program stored in the storage apparatus 102, deploying the processing program to the memory 103, and executing the processing program. Note that the following description will be provided under the assumption that the present generation processing is started upon detection of, for example, setting of a target region inside a display region related to read illustration data, and performance of an operation input related to the execution of the color spreading function.

In step S401, the control unit 101 selects a target layer. Although the following description will be provided under the assumption that a target layer is selected based on an operation input performed by the user in relation to layer selection in the generation processing of the present embodiment, embodiments of the present invention are not limited to this. For example, in a mode where a layer group is provided in illustration data on a part-by-part basis, a layer included in a corresponding layer group may be selected by default on the basis of the status of selection of a part.

In step S402, the control unit 101 determines whether a plurality of target layers exist. The control unit 101 causes processing to proceed to step S403 in a case where it has determined that a plurality of target layers exist, and causes processing to proceed to step S407 in a case where it has determined that a plurality of target layers do not exist (one target layer exists).

In step S403, the control unit 101 generates an integrated image in which image elements (source elements) in the target layers have been integrated.

In step S404, the control unit 101 generates a reference image on the basis of the integrated image. Specifically, the control unit 101 uses, as the reference image, an image that has been obtained as an inference result by inputting information of the integrated image and a target region to the learned model.

In step S405, the control unit 101 divides the reference image into regions.

In step S406, based on information of the result of the division into regions in step S405, the control unit 101 generates image elements (complementary elements) in the target region that respectively correspond to the target layers. For example, the control unit 101 selects the target layers in order, and inputs information of a source element in each layer and the target region to the learned model, thereby obtaining an image as an inference result; then, a complementary element corresponding to the layer is generated by extracting, from the obtained image, pixels at the position corresponding to the divided region corresponding to the layer.

On the other hand, in a case where it has been determined that a plurality of target layers do not exist in step S402, the control unit 101 generates an image element (complementary element) in the target region corresponding to the target layer in step S407. Specifically, the control unit 101 uses, as the complementary element in the target region corresponding to the target layer, an image that has been obtained as an inference result by inputting information of a source element in the target layer and the target region to the learned model.

In step S408, the control unit 101 adds a new layer(s) to the illustration data, stores the generated complementary element(s) therein, and ends the present generation processing. Here, in a case where the complementary elements have been generated with respect to the plurality of target layers, the control unit 101 stores the respective complementary elements in different layers in the present step. At this time, it is assumed that the control unit 101 stores the complementary elements in the respective layers in correspondence with the interlayer hierarchical relationship among the plurality of target layers corresponding to the complementary elements.

As described above, according to the image processing apparatus of the present embodiment, an image element in a desired region can be efficiently generated in conformity with a layer structure of illustration data.

Note that the mode that has been exemplarily shown using FIG. 3A to FIG. 3G has been described under the assumption that the complementary element restricted to the corresponding divided region in the reference image 331 is generated for each target layer. However, the mode of generation of the complementary elements can be modified as follows in consideration of versatility in revising of image elements to which color spreading has been applied.

For example, in a case where the generated complementary element 343 does not indicate predetermined coloring, it is expected that the user will designate the layer 351 to make a revision after the generation. At this time, if a revision is made to delete image information of a partial region of the complementary element 343 (deletion of coloring), a gap with no coloring will emerge inside the target region 311. That is to say, in the mode shown in FIG. 3A to FIG. 3G, as the complementary element 344 generated for the source element in the layer 302 has been generated in a region that does not overlap the complementary element 343, in a case where a part of the complementary element 343 is deleted in the layer 351, the same position in the lower-level layer 352 can appear as a gap as no coloring exists there. In this case, after revising the image element in the layer 351, the user needs to revise the image element in the layer 352 to place it in a defect-free state.

Therefore, with regard to a layer which is included among the selected target layers and which is other than the topmost layer, the complementary element of this layer may be generated with respect to a region obtained by adding the divided regions corresponding to all layers above this layer to the divided region corresponding to this layer. That is to say, in the example shown in FIG. 3F, each of the complementary element 343 corresponding to the layer 301 and the complementary element 344 corresponding to the layer 302 is restricted to the divided region 332 or 333 shown in the reference image 331; however, with regard to the complementary element corresponding to the layer 302 which is not the topmost layer, the complementary element is generated with respect to a region obtained by adding the divided region 332 to the divided region 333. In the example shown in FIG. 3D, as there are two types of target layers, a region in which the complementary element should be generated for the layer 302 is a region obtained by adding the divided region 332 to the divided region 333 in the reference image 331, namely, the target region (the entire region of the reference image 331).

In this case, too, the complementary element corresponding to the layer 302 is occluded by coloring of the complementary element 343 corresponding to the upper-level layer 301, and consequently, color spreading similar to that of FIG. 3E can be realized with respect to the target region. In this mode, no matter how the complementary element 343 in the layer 351 is revised, no gap will emerge, and versatility in revising is improved.

### First Modification Example

Although the above embodiment has been described in relation to a mode in which the source elements of the target layers are all “coloring”, embodiments of the present invention are not limited to this. The target layers can include a layer that stores “line art” as an image element. In this mode, the reference image inferred by the learned model on the basis of the integrated image includes the image element of the line art. Therefore, in division of the reference image into regions, a region in which pixels equivalent to the line art are dispersed is specified as a divided region corresponding to the target layer of the line art. In this case, a complementary element may be generated by extracting pixels of the divided region corresponding to the target layer of the line art from an image of the size of the target region that has been inferred while using a source element in this layer as an input, or a pixel group of the line art extracted from the reference image in division of the reference image into regions per se can be used as a complementary element in this layer.

### Second Embodiment

The above first embodiment has been described in relation to an example in which the present invention is applied to generation of a complementary element when applying color spreading by setting a target region. However, the present invention is not limited to being implemented in response to setting of a target region for the purpose of such color spreading, and may be implemented in response to setting of a region for other purposes.

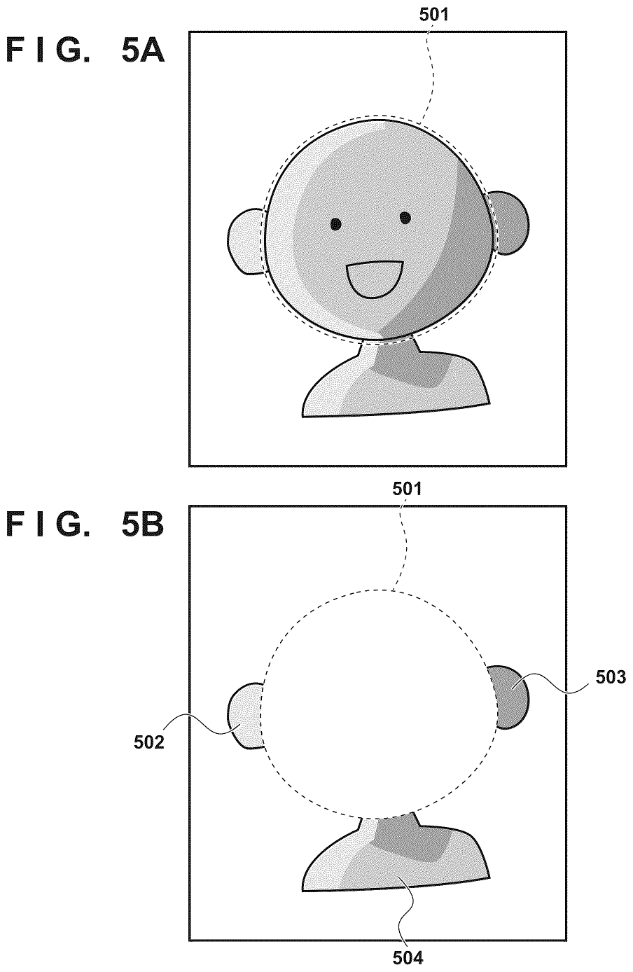

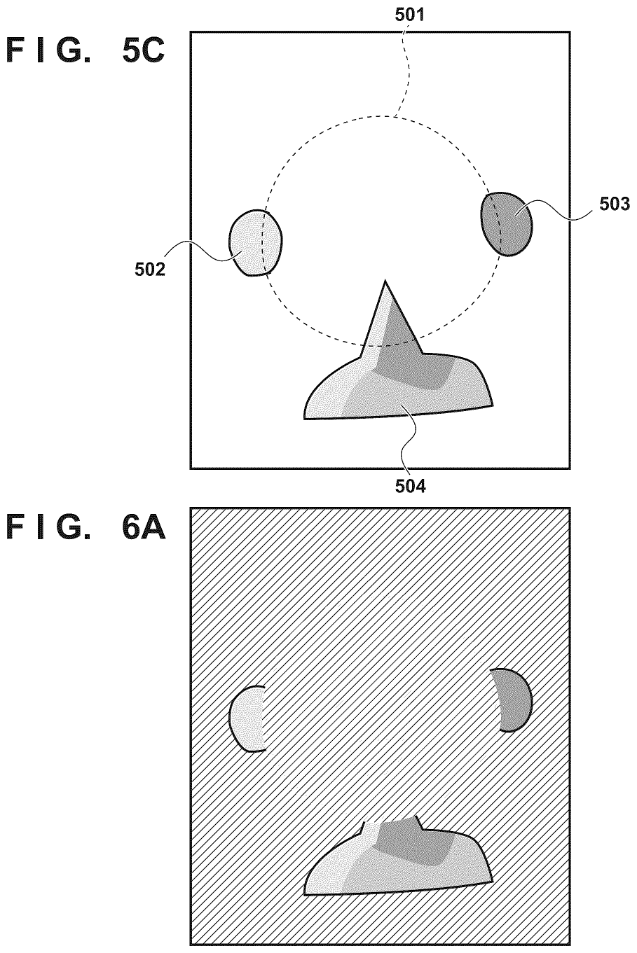

For example, as stated earlier, parts in an illustration related to illustration data are sorted by designating a region 501 inside a display image of this illustration data as shown in, for example, FIG. 5A, and separating image elements dispersed inside this region into a new layer group. When the image elements in the region 501 have been separated into another layer group, pixel information dispersed in this region is excluded (cut out) in the display image from which the image elements have been separated; this leads to a state where images of parts 502, 503, and 504 dispersed around the region 501 are disengaged as shown in FIG. 5B. In the example of the figure, as a result of setting the region 501 so as to enclose a face part in an illustration of a character from the chest up, and separating image elements related to this part into separate layers, the image of the right-ear part 502, the image of the left-ear part 503, and the image of the part 504 of a torso including a neck are placed in a state where they are disengaged and discontinuous.

In a case where a representation model is generated by reflecting such sorting of parts, as a layer group of the parts 502, 503, and 504 is a layer group lower than the face part, the occlusion relationship can change due to geometric transformation of a curved surface related to the face part. Therefore, complementary elements of the parts can be generated as shown in FIG. 5C by performing color spreading while setting target regions that correspond to the shapes of the respective parts inside the region 501 with respect to the parts 502, 503, and 504. In this way, even in a case where the curved surface to which the face part is applied has undergone geometric transformation, the image of each part can be adjusted to present a three-dimensional representation that does not appear strange.

Meanwhile, it is troublesome to repeat an instruction for color spreading by setting a target region with a shape appropriate for a part with respect to each of the parts that have been disengaged by cutting out the region 501, especially in a case where the number of disengaged parts is large. Therefore, in a case where a region for cutting out a part of the display image has been designated for sorting of parts, this region may be used also as a target region for color spreading.

At this time, considering that each of the parts 502, 503, and 504 is to be displayed in a favorable occlusion state even in a case where the curved surface to which the face part is applied has undergone geometric transformation, it is not preferable to perform color spreading that connects these parts together by adding image information to the entirety of the region 501. That is to say, in a mode where the parts 502, 503, and 504 are connected by adding a complementary element with the shape of the region 501, each time the curved surface to which the face part is applied undergoes geometric transformation, it is necessary to adjust (geometrically change) the added complementary element and the curved surfaces to which the parts 502, 503, and 504 are applied. Therefore, the representation model is not likely to be capable of realizing a versatile three-dimensional representation. In view of this, the color spreading function of the present embodiment will be described in relation to a method in which, in a case where a cutout has been performed in a display image in relation to sorting of parts, this cutout region is used as a target region, and complementary elements with shapes that are respectively appropriate for parts dispersed around this target region are generated. That is to say, a description is given of a method in which, in a case where a cutout has been performed in relation to sorting of parts, complementary elements with shapes that are appropriate for the respective parts are generated at a time inside the cutout region (target region), similarly to FIG. 5C.

Incidentally, when a representation model is configured to include curved surfaces that are restricted to parts of an object like a character, the representation model can realize a display that does not appear odd even if a display image generated as a three-dimensional representation is arranged (superimposed) on a desired background. In other words, it is sufficient for the representation model to include curved surfaces that are restricted to significant pixels of parts, and the representation model is configured so that, in illustration data used in generation thereof, image information is not included with respect to pixels that do not correspond to parts. Therefore, in an illustration related to illustration data, pixels that do not include image information are set as transparent pixels without color information.

In this case, in order to generate favorable complementary elements with respect to a target region, processing different from color spreading described in the first embodiment is required.

According to color spreading of the first embodiment, an inference result of a reference image in which every pixel of a target region is filled is obtained by inputting an integrated image obtained by integrating source elements in a plurality of target layers to a learned model, and complementary elements corresponding to the respective target layers are generated based on information of each divided region in this reference image. That is to say, in color spreading, as every pixel in the target region belongs to a divided region corresponding to one of the target layers, complementary elements are consequently generated in the entirety of the target region.

In contrast, in a mode in which a cutout region related to sorting of parts is used as a target region, it is preferable to generate only complementary elements whose shapes conform with the respective parts that have been disengaged, and to set the rest as transparent pixels, and thus it is necessary to classify partial pixels in the target region into a divided region that does not correspond to any target layer. In other words, in a mode where a cutout region is used as a target region, it is preferable to generate a reference image, which is based on an integrated image, so that it includes not only divided regions corresponding to source elements in target layers, but also divided regions corresponding to transparent pixels.

In order to obtain such a reference image, in a mode where a cutout region is used as a target region, an integrated image is generated by converting transparent pixels into information of significant pixels. That is to say, in generating an integrated image to be input to the learned model, not only image elements (source elements) in target layers, but also pixels that are transparent pixels in all target layers (pixels that do not include significant pixel information in any target layer), are included. Here, transparent pixels are pixels which have pixel values including α values set at 0, and which do not include any color information; however, when generating an integrated image, the transparent pixels are assigned pixel values which include α values set at 1, and which indicate a predetermined color (e.g., white).

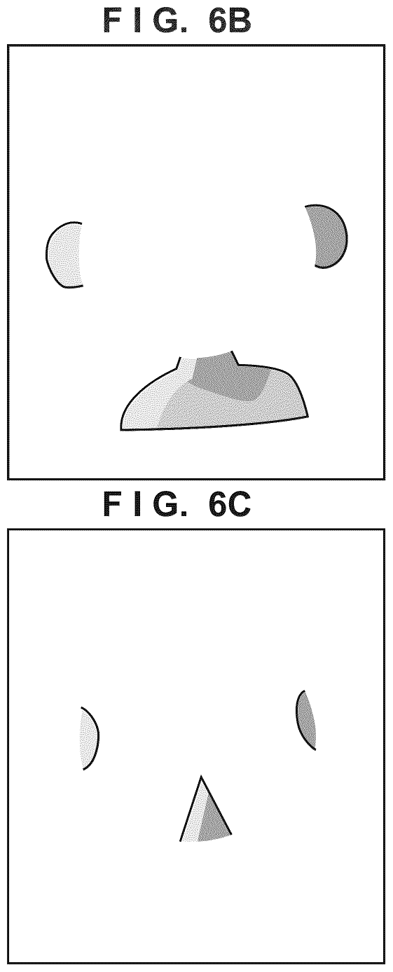

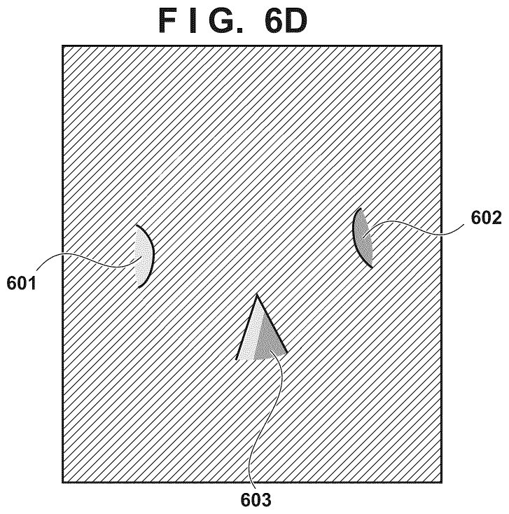

A description is given of a case where, for example, an illustration in a state where a face part has been cut out is in the mode shown in FIG. 5B, and layers of line art and coloring that compose this illustration have been selected as target layers. At this time, in a case where the integration has been performed without including pixels that are transparent pixels in all target layers, an image that does not have pixel values in a hatched region is generated as shown in FIG. 6A. In contrast, in a case where the integration is performed after converting pixels that are transparent pixels in all target layers into colored pixels showing white, an image without a region that does not have pixel values is generated as shown in FIG. 6B.

Here, the predetermined color is set to specify pixels to be recognized as transparent pixels in subsequent image processing, and is not limited to white. For example, the predetermined color can be selected from among colors that are different from any of the pixels composing the illustration related to the illustration data.

Therefore, an image that includes pixels of the predetermined color can be inferred with respect to a target region by inputting, to the learned model, an integrated image generated by converting pixels that are transparent pixels in all target layers into pixels of the predetermined color. Then, a reference image can be generated by changing the pixels of the predetermined color in this image to transparent pixels. Furthermore, by dividing the obtained reference image into regions, an image element (complementary element) corresponding to each target layer can be generated based on a divided region dispersed nearby with respect to each of parts dispersed around the target region.

For example, an image shown in FIG. 6C can be obtained with respect to the target region by causing the learned model to make an inference while using the integrated image of FIG. 6B as an input. Then, a reference image shown in FIG. 6D can be obtained by changing pixels of the predetermined color in this image to transparent pixels. In the example of FIG. 6D, the following can be specified from the reference image: a divided region including line art and coloring related to the complementary element of the part 502, from an image element 601 dispersed nearby the part 502 inside the reference image; a divided region including line art and coloring related to the complementary element of the part 503, from an image element 602 dispersed nearby the part 503 inside the reference image; and a divided region including line art and coloring related to the complementary element of the part 504, from an image element 603 dispersed nearby the part 504 inside the reference image.

In this way, when a cutout region has been designated in a display image for sorting of parts, image elements (complementary elements) with shapes conforming with the respective parts dispersed around this region can be generated with respect to the cutout region; accordingly, the user's trouble can be reduced.

### Second Modification Example

The above first modification example has been described in relation to a mode where, in a case where line art and coloring have been selected as target layers, a divided region corresponding to the line art is extracted from a reference image that has been inferred based on an integrated image obtained by integrating image elements in these target layers, and a complementary element of line art inside a target region is generated. Meanwhile, regarding an integrated image including line art, as an inference is made while considering the line art as one form of coloring, there are cases where the inference result does not necessarily indicate the features unique to the line art.

Line art is likely to be used in a representation of an edge portion or a boundary portion of coloring in an illustration. For this reason, a complementary element (line art) in a target region that has been inferred by the learned model on the basis of a source element in a target layer of line art can include information that is beneficial in terms of specification of a region in which a complementary element of coloring is to be generated with respect to the target region. Especially, in generating complementary elements with respect to a cutout region related to sorting of parts, there are cases where the shape of a complementary element of coloring inside the cutout region can be favorably specified by referring to the features unique to line art.

Therefore, in generating complementary elements related to a target region, whether a source element in a target layer is line art or coloring may be distinguished, and a part of processing may be changed in accordance with the result of this distinction. Here, whether an image element (source element) stored in a target layer is line art may be distinguished by, for example, referring to attribute information of the target layer set by the user, or performing image analysis on image elements in respective target layers. In the case of image analysis, a skeleton image related to an image element in a target layer can be generated using, for example, a thinning algorithm of Zhang-Suen, and the distinction can be made based on a value of a ratio between the skeleton length (the number of pixels) in this skeleton image and the area (the number of pixels) occupied by the image element.

In a case where an image element stored in a target layer is line art, an image including line art arranged inside a region of the predetermined color can be generated by converting transparent pixels in this target layer into pixels of the predetermined color, similarly to the second embodiment. Therefore, by inputting this image to the learned model, a complementary element of line art can be inferred with respect to a target region. The complementary element of the line art obtained through this inference can indicate the features unique to the line art better than a reference image obtained based on an integrated image in which image elements of the line art and coloring have been integrated.

Meanwhile, regarding a target region, the features of an input image differ between an inference result that is based only on a source element of line art and an inference result that is based on an integrated image obtained by integrating source elements of the line art and coloring, and thus the shape of a complementary element of the line art related to the target region can differ therebetween. As a result, there is a possibility that the complementary element of the line art related to the target region based on the former inference result does not correspond to the complementary element of coloring related to the target region based on the latter inference result (a region defined by the line art does not match a region occupied by the image element of coloring).

To resolve such a discrepancy between the complementary elements, a further adjustment may be made to a group of complementary elements that have been generated with respect to the target region. In one mode, the complementary element that is based only on the line art may be prioritized, and the complementary element of coloring may be adjusted so as to conform with this complementary element. This adjustment can include processing for deleting coloring that spreads outside a region defined by the complementary element that is based only on the line art, or supplementing a shortage of pixels in a region extending to a boundary with this defined region by making copies of pixels of the complementary element of coloring, for example. In another mode, a final complementary element related to line art may be generated by performing weighted addition of a complementary element that is based only on line art and a complementary element related to line art specified based on a reference image. In this case, too, it is sufficient to similarly make an adjustment to bring a complementary element of coloring into conformity with the final complementary element related to the line art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A computer-readable recording medium including a program recorded therein, the program editing illustration data having a layer structure in which image elements for forming a display image of an illustration are separated into a plurality of layers,
the program causing a computer to execute:
obtainment processing for obtaining the illustration data to be edited;
setting processing for setting a target region inside a display image related to the illustration data obtained in the obtainment processing;
selection processing for selecting two or more layers as target layers from among the plurality of layers; and
generation processing for, with respect to the target layers selected in the selection processing, generating image elements in the target region on a basis of image elements outside the target region,
the generation processing including
first generation processing for generating the image elements in the target region as a reference image on a basis of an integrated image generated by integrating image elements in the target layers, and
second generation processing for, with respect to each of the target layers, generating the image element in the target region corresponding to the target layer on a basis of the reference image and the image element outside the target region in the target layer.

2. The recording medium according to claim 1, wherein
the generation processing further includes division processing for dividing the reference image into regions, and
with respect to each of the target layers, the second generation processing generates the image element in the target region corresponding to the target layer on a basis of region information indicating a region corresponding to the target layer inside the reference image.

3. The recording medium according to claim 2, wherein
with respect to each of the target layers, the second generation processing generates the image element in the target region corresponding to the target layer by extracting an image of the region indicated by the region information from an intermediate image in the target region generated based on the image element outside the target region in the target layer.

4. The recording medium according to claim 2, wherein
with respect to each of the target layers, the second generation processing generates the image element in the target region corresponding to the target layer by generating an image of the region indicated by the region information on a basis of the image element outside the target region in the target layer.

5. The recording medium according to claim 2, wherein
a hierarchical relationship is defined with respect to the plurality of layers, and
with respect to a first layer among the target layers, the second generation processing generates the image element in the target region corresponding to the first layer by extracting an image of a region obtained by adding a region indicated by the region information of a second layer higher than the first layer to a region indicated by the region information of the first layer from an intermediate image in the target region generated based on the image element outside the target region in the first layer.

6. The recording medium according to claim 2, wherein
a hierarchical relationship is defined with respect to the plurality of layers, and
with respect to a first layer among the target layers, the second generation processing generates the image element in the target region corresponding to the first layer by generating an image of a region obtained by adding a region indicated by the region information of a second layer higher than the first layer to a region indicated by the region information of the first layer on a basis of the image element outside the target region in the first layer.

7. The recording medium according to claim 2, wherein
the generation processing further includes specification processing for specifying the target layers corresponding to the respective regions obtained by dividing the reference image, and outputting the region information.

8. The recording medium according to claim 7, wherein
the specification processing specifies the target layers corresponding to the respective regions on a basis of at least one of color dispersions in the respective regions obtained by dividing the reference image, and continuity with the image elements in the target layers.

9. The recording medium according to claim 1, wherein
the program further causes the computer to execute separation processing for separating an image element in a partial region inside the display image related to the illustration data into a new layer, and
in a case where the separation processing is executed,
the setting processing sets the partial region as the target region, and
in a case where the integrated image includes transparent pixels, the first generation processing generates the reference image by changing the transparent pixels to pixels of a predetermined color, and changing pixels of the predetermined color in the image elements in the target region generated based on the changed integrated image to transparent pixels.

10. The recording medium according to claim 1, wherein
the second generation processing generates the image element in the target region corresponding to each of the target layers as an image element of a layer different from the target layers.

11. The recording medium according to claim 1, wherein
the generation processing generates the image elements in the target region by causing a learned model to make an inference while using the image elements outside the target region as inputs, the learned model having been constructed to infer an image of a designated region on a basis of an image around the designated region.

12. An image processing apparatus that edits illustration data having a layer structure in which image elements for forming a display image of an illustration are separated into a plurality of layers, the image processing apparatus comprising:
at least one processor; and
at least one memory storing a computer program, which causes the at least one processor to function as following units:
obtaining means for obtaining the illustration data to be edited;
setting means for setting a target region inside a display image related to the illustration data obtained by the obtaining means;
selecting means for selecting two or more layers as target layers from among the plurality of layers; and
generating means for, with respect to the target layers selected by the selecting means, generating image elements in the target region on a basis of image elements outside the target region,
wherein the generating means includes
first generating means for generating the image elements in the target region as a reference image on a basis of an integrated image generated by integrating image elements in the target layers, and
second generating means for, with respect to each of the target layers, generating the image element in the target region corresponding to the target layer on a basis of the reference image and the image element outside the target region in the target layer.

13. An image processing method that edits illustration data having a layer structure in which image elements for forming a display image of an illustration are separated into a plurality of layers, the image processing method comprising:
obtaining the illustration data to be edited;
setting a target region inside a display image related to the obtained illustration data;
selecting two or more layers as target layers from among the plurality of layers; and
with respect to the selected target layers, generating image elements in the target region on a basis of image elements outside the target region,
wherein the generating includes
generating the image elements in the target region as a reference image on a basis of an integrated image generated by integrating image elements in the target layers, and
with respect to each of the target layers, generating the image element in the target region corresponding to the target layer on a basis of the reference image and the image element outside the target region in the target layer.
